(19) United States
(12) Patent Application Publication
(10) Pub. No.: US 2005/0050452 A1
(43) Pub. Date: Mar. 3, 2005

(54) Systems and methods for generating an electronically publishable document

(76) Inventors: Wade D. Weitzel, Loveland, CO (US); Archie Carrington, Fort Collins, CO (US); Jeremy Cook, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/649,257

(22) Filed: Aug. 27, 2003

(51) Int. Cl. G06F 17/00

(52) U.S. Cl. 715/513

(57) ABSTRACT

In one embodiment, a method for generating an electronically publishable document, comprises receiving image data corresponding to a physical document, segmenting the image data, creating a markup language file containing the segmented image data, and embedding a graphical user interface within the markup language file that enables navigation to segmented image data as selected by the user.

### BACKGROUND

At the present time, a number of document formats enable users to encode and distribute content. In the present context, the term “document” refers to any suitable data structure containing any of text, line art, images, video, audio, and/or the like that is suitable for electronic distribution or publication. For example, markup languages, such as the hypertext markup language (HTML), dynamic HTML, and extensible markup language, are commonly utilized to create and provide document content to users via the Internet. The creation of a markup language document can be complex. Although a variety of markup language document editors and other markup language applications exists, the creation of markup language documents typically requires a number of steps to be performed manually. As the desired degree of sophistication of a markup language document increases, a corresponding greater degree of skill of the individual responsible for creating the document is typically necessitated.

Other proprietary formats exist that allow individuals with relatively limited technical experience to create sophisticated documents. For example, the ABODE® PDF format is utilized to encode documents for distribution. The PDF format is advantageous, because it provides a degree of control over the presentation of a document irrespective of the system utilized by a recipient of the document. Additionally, the PDF format provides document structure. For example, a “tab” mechanism may be utilized to denote pages associated with the beginning of a chapter or particular topic. However, the PDF format has a number of limitations. In particular, the PDF format is proprietary. Accordingly, to create a document according to the PDF format, specialized software and an appropriate software license is necessary. Moreover, the recipients of the document must possess a reader application adapted to the PDF format. Also, the distribution of PDF documents via the Internet is somewhat problematic in that the PDF reader application must be launched within a browser application, whenever a user accesses a PDF document via the browser.

Other proprietary formats are available such as the MICROSOFT® WORD and POWERPOINT formats. WORD document formats are most useful for document creation. The WORD document format is not in wide-spread used for electronic document publication, because the advanced features in the WORD format are viewed as being cumbersome and difficult to use. The POWERPOINT format enables a “slide show” presentation format that is generally desirable for the publication of content via the Internet and otherwise. However, the POWERPOINT format is proprietary and requires the recipients of POWERPOINT documents to possess or download a reader application for viewing POWERPOINT documents. Moreover, the navigation capabilities of POWERPOINT documents are generally limited to the “slide show” ordering of content within the document.

### SUMMARY

In one embodiment, a method for generating an electronically publishable document, comprises receiving image data corresponding to a physical document, segmenting the image data, creating a markup language file containing the segmented image data, and embedding a graphical user interface within the markup language file that enables navigation to segmented image data as selected by the user.

In another embodiment, a computer readable medium, containing executable instructions for generating an electronically publishable document, comprises code for segmenting image data of a physical document, code for creating a markup language file, code for encapsulating the segmented image data within the markup language file, and code for embedding a graphical user interface within the markup language file that enables navigation to the segmented image data in response to user input.

In yet another embodiment, a system for generating an electronically publishable document, comprises means for providing image data, means for performing page segmentation on the image data, means for creating a markup language file containing segmented data generated by the means for performing page segmentation, and means for embedding a graphical user interface within the markup language file to enable navigation to the segmented data according to user input.

### DESCRIPTION OF THE DRAWINGS

FIG. 1 depicts a system for generating documents that contain a graphical user interface according to representative embodiments.

FIG. 2 depicts a flowchart for segmenting image data.

FIG. 3 depicts a flowchart for generating a document that contains a graphical user interface from segmented data according to representative embodiments.

FIG. 4 depicts a browser display of a document generated according to representative embodiments.

### DETAILED DESCRIPTION

Representative embodiments are directed to systems and methods for generating a document containing a graphical user interface (GUI). Representative embodiments may operate by receiving image data from a scanner or other suitable digital imaging device (e.g., a digital camera). The image data may comprise multiple pages of an imaged document. The image data may be processed to segment graphical images, lines, geometric images, text, and/or the like. A markup language file or document is created and the appropriate markup language elements (e.g., tags and suitable data) are inserted into the markup language file that corresponds to the segmented elements from the image data. The text data segmented from the image data may be subjected to optical character recognition processing. From the converted text, common section identifiers (such as chapter, section, forward, glossary, index, and/or the like) may be located in the image data. The markup language file may be modified to contain link controls in, for example, a table of contents section that enables user navigation to the relevant sections in response to typical browser input. Moreover, document paging controls are added to the markup language file to enable user navigation. Furthermore, search logic in the form of a suitable scripting language is embedded in the markup language file to enable user navigation in response to user search queries.

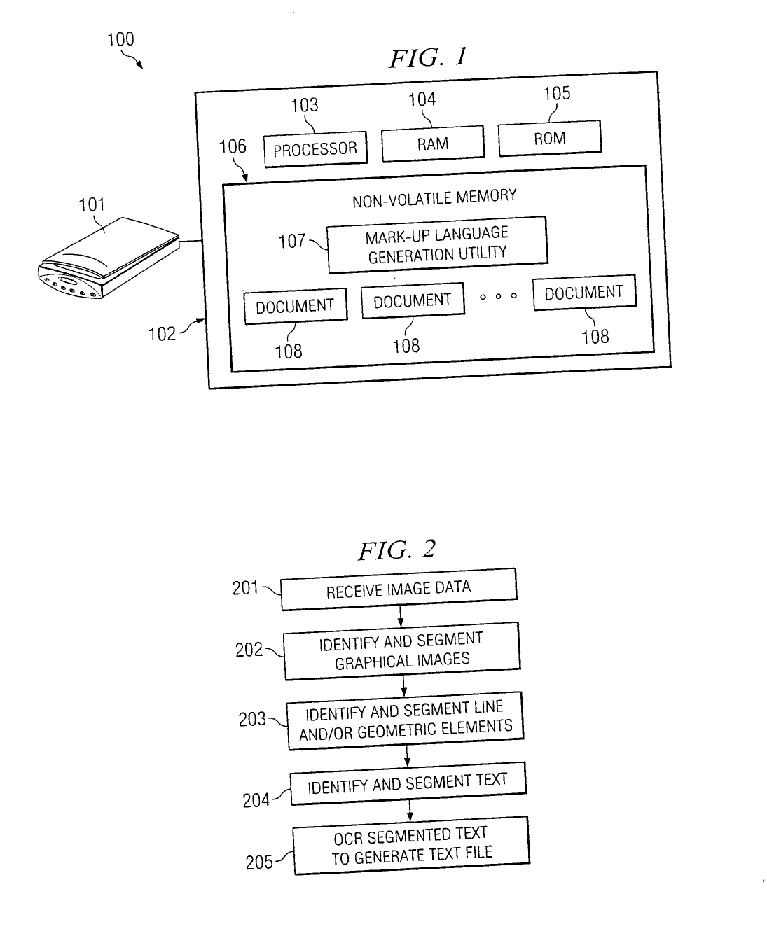

FIG. 1 depicts system 100 that utilizes executable instructions to generate documents that contain a graphical user interface. The documents are encoded utilizing a commonly available, architecture-neutral format. Suitable formats include the various available markup languages, such as the hypertext markup language (HTML), dynamic HTML (DHTML), extensible markup language (XML), and/or the like. By utilizing a commonly available, architecture-neutral format, the generated documents may be freely distributable. That is, the recipients of the generated documents may receive and view the documents utilizing commonly available browser applications without needing to acquire software licenses for a proprietary application. Moreover, the mechanism for publishing the generated documents is relatively straight forward. The generated documents may be published by posting the documents on a suitable web server. Additionally, the generated documents may be updated from time to time as desired by the publisher.

Representative embodiments generate documents from image data. In system 100, scanner 101 or any other suitable digital imaging device images physical documents. Scanner 101 may comprise a document feeder (not shown) to receive multiple pages to be scanned in succession. Scanner 101 may be implemented using any number of scanners that are widely available on a commercial basis. Digital data is communicated from scanner 101 to computer system 102 for further processing.

Computer system 102 may be implemented utilizing any suitable computer platform, such as a personal computer (PC). Computer system 102 comprises processor 103 that operates under the control of executable instructions. Computer system 102 further comprises random access memory (RAM) 104 and read only memory (ROM) 105 that store program data and user data. Computer system 102 comprises non-volatile memory 106, such as a suitable hard disk drive. The executable instructions defining markup language generation utility 107 may be stored on the computer-readable medium of non-volatile memory 106. When operated by the user, markup language generation utility 107 generates documents 108 that comprise respective graphical user interfaces according to representative embodiments. Documents 108 may also be stored in non-volatile memory 106.

FIG. 2 depicts a flowchart for processing image data that may be implemented by markup language generation utility 107. In step 201, image data is received from a scanner or other suitable imaging device. In step 202, graphical images (such as pictures, photographs, icons, and/or the like) are identified and segmented from the image data. In step 203, line art and/or other geometric elements are identified and segmented from the image data. In step 204, text is identified and segmented from the image data. The identification of photographs, line art, and/or text in image data is referred to as “page decomposition.” Page decomposition may occur according to a “bottom-up” approach in which local information is used to identify connected components and to group connected components in an iterative manner. Page decomposition may also occur utilizing a “top-down” approach in which global information (e.g., black and white stripes) are used to identify segments of relevant data. A discussion of page decomposition is given in Parameter-Free Geometric Document Layout Analysis, IEEE Transactions on Pattern Analysis and Machine Intelligence, Vol. 23, No. 11, November 2001 by Seong-Whan Lee and Dae-Seok Ryu, which is incorporated herein by reference. Also, U.S. Pat. No. 5,546,474, which is incorporated herein by reference, discloses a document analysis algorithm that enables the classification of image data into photo-regions and non-photo regions to facilitate page decomposition. In step 205, the segmented text data is subjected to known optical character recognition (OCR) processing to generate a text file.

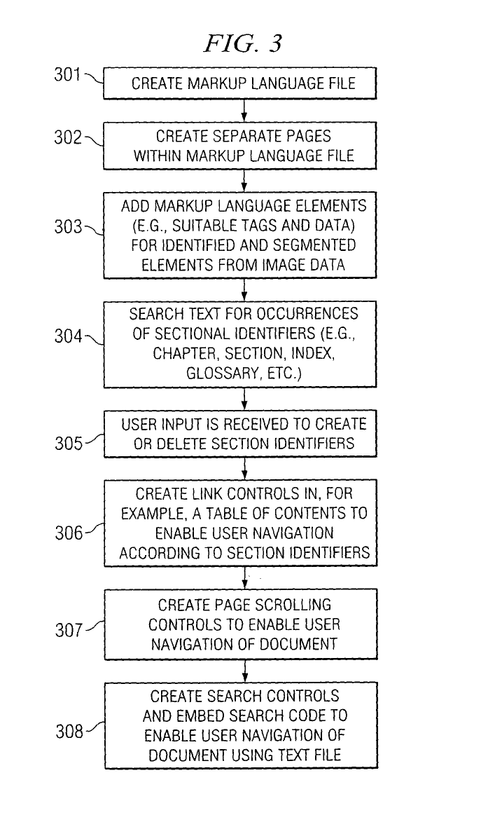

Using the segmented data and the text file, markup language generation utility 107 generates a document that contains a graphical user interface to facilitate user navigation within the document. Markup language generation utility 107 may implement the process flow of the flowchart shown in FIG. 3. In step 301, a markup language file is created. In step 302, separate pages are created within the markup language file. The pages correspond to the number of physical pages imaged by the user. The separate pages in the file may be created utilizing suitable page identifiers. In step 303, markup language elements (e.g., suitable tags and data) are added to the markup language file for each of the identified and segmented elements from the image data. The markup language elements are added within respective portions of the markup language file in a manner that corresponds to the original paginated image data. In step 304, the text file, which was generated from the optical character recognition processing, is searched for occurrences of section identifiers or keywords (such as chapter, index, glossary, and/or the like). In step 305, user input may be received to create additional section identifiers or to delete autonomously created section identifiers that are not desired by the user. In step 306, link controls are added. For example, a table of contents may be added to the markup language document utilizing suitable link tags. The link controls provide graphical user interface functionality to enable the user to select a section identifier to navigate to the portion of the markup language document associated with the section identifier. In step 307, page scrolling controls are added to the markup language file to enable user navigation of the document. In step 308, search controls and executable code that enable user navigation of the document are added to the file. Other graphical user interface elements may be added to the markup language file as appropriate for the respective content as desired.

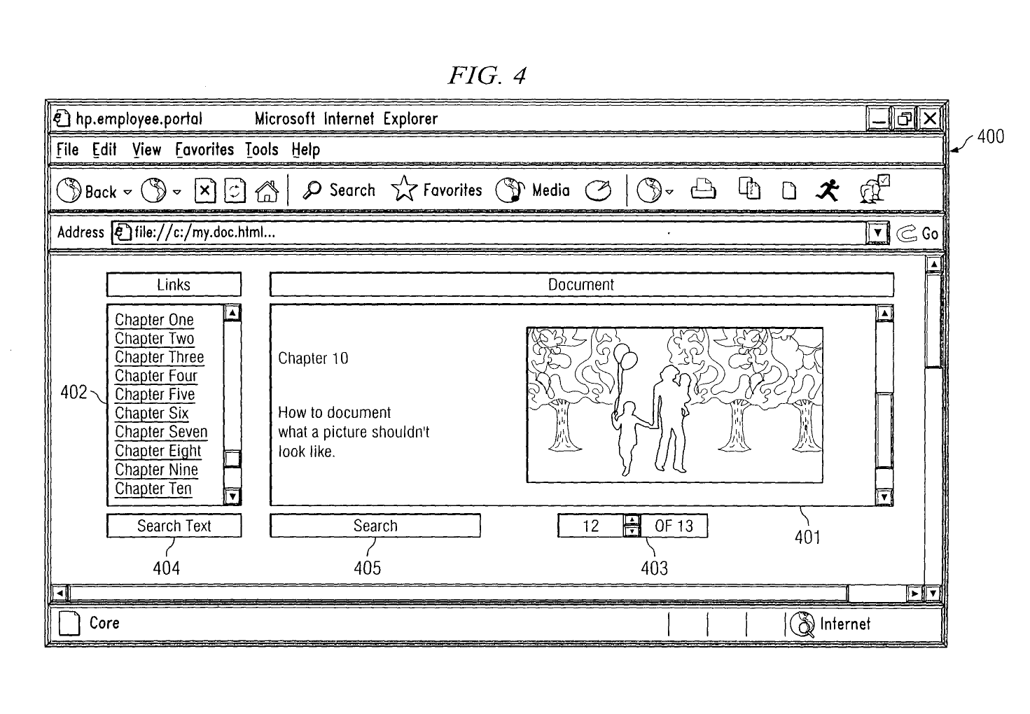

FIG. 4 depicts browser display 400 of a document generated according to representative embodiments. Display 400 comprises content section 401 in which the text, line art, and graphical images of the generated document are displayed. Display 400 provides a graphical user interface for user navigation of the document that is within the browser display. The graphical user interface comprises link section 402, page controls 403, search text box 404, and search button 405. Link section 402 comprises a plurality of section identifiers, shown as Chapters One through Ten. By selecting one of the section identifiers, the user may navigate the document. Specifically, when the user selects one of the section identifiers, the corresponding portion of the document is displayed within content section 401. Display 400 further comprises paging controls 403 that enable the user to page through the document as desired and thereby causing different portions of the document to be displayed in content section 401. Display 400 further comprises search text box 404 to receive a user query and search button 405 to activate the search logic. For example, a JAVASCRIPT™ may be embedded in the generated document to implement the search logic. The script parses the user query entered in search text box 404 and identifies matching sections of content of the document in reference to the optically recognized characters. The script then causes content section 401 to display a portion of the document matching the user query.

By performing the processing flow illustrated in FIG. 3, representative embodiments enable the generation of a document that comprises its own graphical user interface. As a result, the user may navigate through the document without restriction to the functionality of the application (e.g., the browser) utilized to view the application. Instead, the graphical user interface may be customized based on the content of the document and the desires of the document publisher. Moreover, the document is generated in a format that is not restricted to a proprietary standard. Accordingly, the generated document may be displayed in substantially the same manner on any suitable platform without requiring the user to acquire a license for a proprietary software application.

1. A method for generating an electronically publishable document, comprising:
receiving image data corresponding to a physical document;
segmenting said image data;
creating a markup language file containing said segmented image data; and
embedding a graphical user interface within said markup language file that enables navigation to segmented image data as selected by the user.

2. The method of claim 1 further comprising:
performing optical character recognition (OCR) processing of the segmented imaged data.

3. The method of claim 2 further comprising:
searching text data generated from said OCR processing to identify section identifiers.

4. The method of claim 3 further comprising:
creating a plurality of links in said markup language file utilizing said section identifiers to enable user navigation to said segmented image data associated with said section identifiers.

5. The method of claim 4 wherein said plurality of links are created in a table of contents section of said markup language file.

6. The method of claim 2 wherein said embedding a graphical user interface comprises:
embedding a script in said markup language file that performs a search of document text in response to search queries.

7. The method of claim 1 wherein said physical document is a multi-page document, said method further comprising:
creating page identifiers within said markup language file.

8. The method of claim 7 wherein said embedding a graphical user interface comprises:
providing user controls to enable user navigation according to said page identifiers.

9. The method of claim 1 wherein said embedding a graphical user interface comprises:
receiving manual identification of ones of said segmented image data; and
creating links within said markup language file to enable user navigation to said manually identified ones of said segmented image data.

10. A computer readable medium containing executable instructions for generating an electronically publishable document, said computer readable medium comprising:
code for segmenting image data of a physical document;
code for creating a markup language file;
code for encapsulating said segmented image data within said markup language file; and
code for embedding a graphical user interface within said markup language file that enables navigation to said segmented image data in response to user input.

11. The computer readable medium of claim 10 further comprising:
code for generating a text file from image data segmented by said code for segmenting.

12. The computer readable medium of claim 11 further comprising:
code for creating a search control within said markup language file to enable user navigation according to text queries.

13. The computer readable medium of claim 11 further comprising:
code for searching said text file to identify keywords indicative of a section of said physical document; and
code for creating links in said markup language document to enable user navigation to segmented image data corresponding to keywords identified by said code for searching.

14. The computer readable medium of claim 10 further comprising:
code for creating markup language tags in said markup language file to indicate segmented image data corresponding to pages of said physical document.

15. The computer readable medium of claim 14 further comprising:
code for embedding a user control in said markup language file to enable user navigation to a selected page.

16. The computer readable medium of claim 14 further comprising:
code for embedding a user control in said markup language file to enable user navigation forward or backward according to said markup language tags that indicate segmented image data corresponding to pages of said physical document.

17. The computer readable medium of claim 10, wherein said code for segmenting segments image data corresponding to text elements, line art elements, and graphical image elements.

18. A system for generating an electronically publishable document, comprising:
means for providing image data;
means for performing page segmentation on said image data;
means for creating a markup language file containing segmented data generated by said means for performing page segmentation; and
means for embedding a graphical user interface within said markup language file to enable navigation to said segmented data according to user input.

19. The system of claim 18 further comprising:
means for performing optical character recognition (OCR) processing upon text data segmented by said means for performing page segmentation.

20. The system of claim 19 further comprising:
means for embedding a search script, in said markup language file, operable to search text data generated by said means for performing OCR processing to enable navigation to ones of said segmented data according to search queries.
